(19) United States
(12) Patent Application Publication
(10) Pub. No.: US 2011/0267534 A1
(43) Pub. Date: Nov. 3, 2011

(54) IMAGE SENSOR PACKAGE AND CAMERA MODULE USING SAME

(75) Inventor: WEN-CHIN TSAI, Tu-Cheng (TW)

(73) Assignee: HON HAI PRECISION INDUSTRY CO., LTD., Tu-Cheng (TW)

(21) Appl. No.: 12/815,354

(22) Filed: Jun. 14, 2010

(30) Foreign Application Priority Data
Apr. 28, 2010 (TW) 99113394

(51) Int. Cl. H04N 5/225; H01J 5/02

(52) U.S. Cl. 348/374; 250/239; 348/E05.024

(57) ABSTRACT

The image sensor package includes a transparent substrate, a number of conductive patterns, an image sensor, a flexible circuit board. The conductive patterns are distributed on a surface of the transparent substrate. The image sensor is adhered on the transparent substrate and electrically connected to the conductive patterns. The flexible circuit board is electrically connected to the conductive patterns, and defines an opening for receiving the image sensor therein.

### BACKGROUND

1. Technical Field

The disclosure relates to semiconductor packages, and, particularly, to an image sensor package and a camera module using same.

2. Description of Related Art

Flip chip packages allow for miniaturized packaging of chip such as chips used for image sensors. Glass plates are very popular as substrates to support image sensors and provide electrical connection for the image sensors through metal layers attached on the surfaces thereof. However, some part of light incident on the metal layers will stray and will degrade the imaging performance of the image sensor.

Therefore it is desirable to provide an image sensor package and a camera using the image sensor in which the problem can be overcame.

### BRIEF DESCRIPTION OF THE DRAWINGS

FIG. 1 is a cross section view of a camera module in accordance with an exemplary embodiment.

FIG. 2 is a bottom view of a transparent plate of the camera module of FIG. 1.

FIG. 3 is a bottom view of a flexible circuit board of the camera module of FIG. 1.

### DETAILED DESCRIPTION

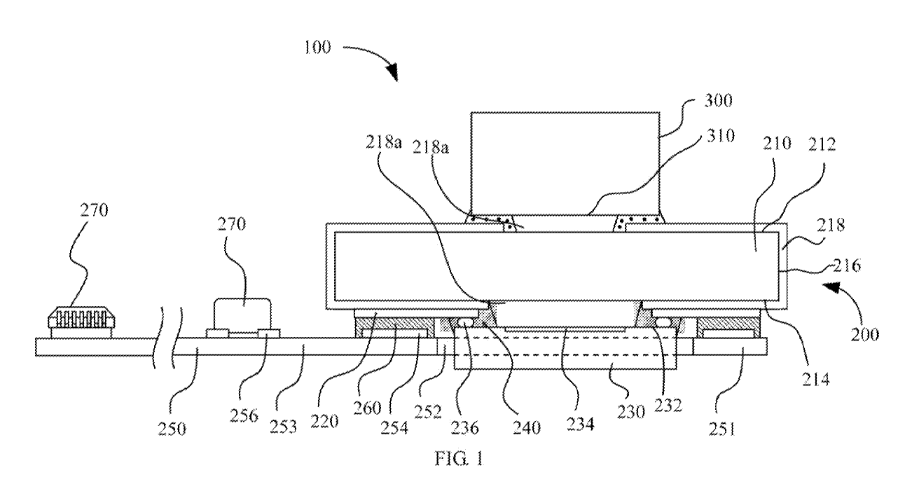

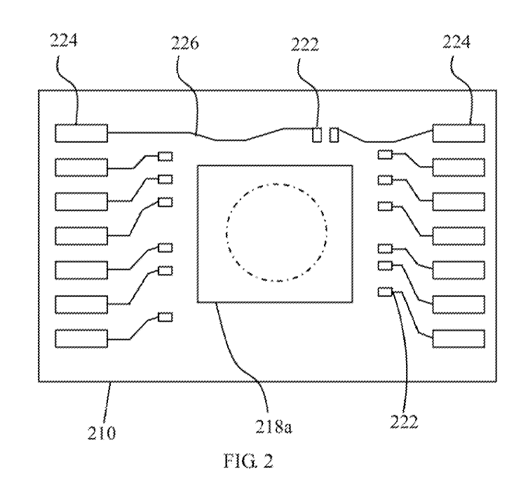

Referring to FIGS. 1-2, a camera module 100 according to an exemplary embodiment, includes an image sensor package 200 and a lens module 300 mounted on the image sensor package 200.

The image sensor package 200 includes a transparent substrate 210, a number of conductive patterns 220 formed on the bottom surface of the transparent substrate 210, an image sensor 230, an adhesive material 240, a flexible circuit board 250, conductive glue 260, and a number of electronic elements 270 such as resistors, capacitors, and transistors. The image sensor 230 is adhered on the transparent substrate 210 with the conductive glue 260, and electrically connected to the conductive patterns 220. An opening 252 is defined in the flexible circuit board 250 for receiving the image sensor 230 therein. The electronic elements 270 are electrically connected to the flexible circuit board 250.

In this embodiment, the transparent substrate 210 is made from glass and includes a top surface 212, a bottom surface 214 opposite to the top surface 212, and a side surface 216 connecting the top surface 212 to the bottom surface 214. The top surface 212 and the bottom surface 214 are made as flat as possible to form a level surface to serve as a relative reference for aligning the lens module 300 with the image sensor 230. A mask 218 covers the top surface 212, the bottom surface 214, and the side surface 216 of the transparent substrate 210 for protecting the transparent substrate 210 from stray light to improve the imaging performance of the camera module 100. Two windows 218a are correspondingly defined on the mask 218 at the top surface 212 and the bottom surface 214 for allowing the desired light to pass therethrough. The mask 218 may be prepared from the materials such as chromium, chromic alloy, titanium and titanic alloy. In the present embodiment, the mask 218 is made from chromic alloy.

The conductive patterns 220 are located on the mask 218 at the bottom surface 214 of the transparent substrate 210. The conductive patterns 220 each include an inner connector 222, an outer connector 224, and a conductive line 226 connecting the inner connector 222 to the outer connector 224. The inner connectors 222 are formed on the transparent substrate 210 around the window 218a of the mask 218. The outer connectors 224 are formed at the periphery of the transparent substrate 210 apart from the inner connectors 222.

The image sensor 230 includes an upper surface 232, a sensitive zone 234 formed on the middle of the upper surface 232, and a number of conductive bumps 236 formed on the upper surface 232 around the sensitive zone 234. The sensitive zone 234 includes a number of photosensitive members (not shown), arrayed in a matrix, for transferring light signals into electrical signals. The conductive bumps 236 are electrically connected to the photosensitive members and electrically connected to the inner connectors 222 of the conductive patterns 220 for transmission of the electronic signals generated by the photosensitive members of the image sensor 230 to an exterior device such as an image processing chip. The image sensor 230 is coaxial with the window 218a formed on the mask 218. The top surface 212 and the bottom surface 214 of the transparent substrate 210 serve as reference planes for precisely positioning the image sensor 230 on the mask 218, thereby ensuring the upper surface 232 of the image sensor 230 is substantially parallel to the top surface 212 and the bottom surface 214.

The adhesive material 240 is applied between the upper surface 232 of the image sensor 230 and the bottom surface 214 of the transparent substrate 210 to cover the conductive bumps 236 and the inner connectors 222. Exemplarily, the adhesive material 240 is made from opaque material for preventing light entering into the gap between the image sensor 230 and the transparent substrate 210.

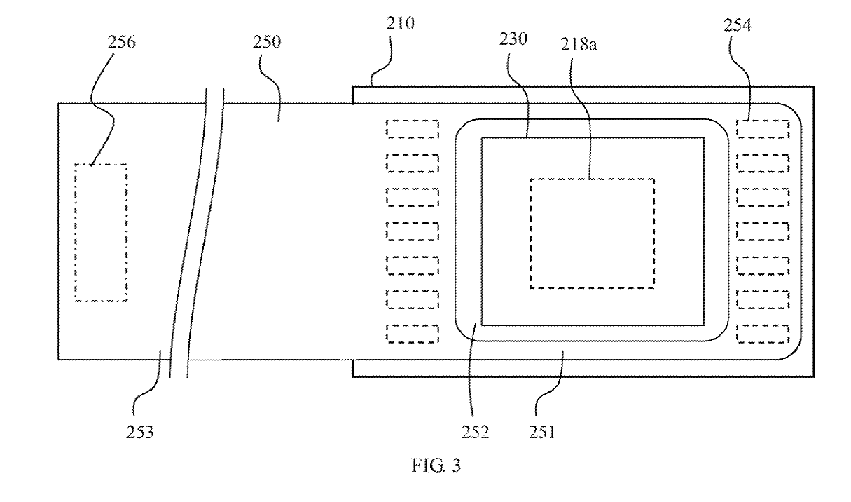

Referring to FIG. 3, the flexible circuit board 250 includes an input end 251 and an output end 253 extending outward from the input end 251. An opening 252 is defined at the input end 251. A number of first conductive pads 254 are mounted on the flexible circuit board 250 around the opening 252 and corresponding to the outer connectors 224 of the conductive patterns 220. A number of second conductive pads 256 are mounted on the output end 253 for connecting to the electronic elements 270. The first conductive pads 254 are electrically connected to the outer connectors 224 via the conductive glue 260.

The conductive glue 260 is exemplarily selected from an anisotropic conductive adhesive and an anisotropic conductive film. In the present embodiment, the conductive glue 260 is anisotropic conductive adhesive that can firmly and electrically interconnecting the flexible circuit board 250 and the transparent substrate 210.

The lens module 300 is configured for capturing desired light and allowing the desired light to project on the sensitive zone 234 of the image sensor 230. The lens module 300 includes a substantially flat bottom 310 directly adhered on the mask 218 at the top surface 212 of the transparent substrate 210 to cover the window 218a. The optical axis of the lens module 300 can be readily arranged perpendicular to and coincident with the center of the image sensor 230 to take advantage of the substantially planar surfaces of the transparent substrate 210 and the substantially flat bottom 310 of the lens module 300. Therefore, the lens module 300 and the image sensor 230 can be precisely aligned with each other to achieve relatively better imaging performance of the camera module 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An image sensor package comprising:
a transparent substrate comprising an upper surface, a lower surface opposite to the upper surface, and a side surface connecting the upper surface to the lower surfaces;
a mask covering on the upper surface, the lower surface, and the side surface of the substrate;
two windows correspondingly defined in the mask at the top surface and the bottom surface of the transparent substrate for passing light therethrough;
a plurality of conductive patterns formed on the mask located at the bottom surface of the transparent substrate;
an image sensor electrically connected to the conductive patterns;
a flexible circuit board electrically connected to the conductive patterns, and defining an opening for receiving the image sensor therein.

2. The image sensor package of claim 1, wherein the image sensor comprises an upper surface and a sensitive zone formed on the middle of the upper surface; the top surface and the bottom surface are absolutely level surface and parallel with each other so as the upper surface of image is capable of substantially parallel with the upper surface and the bottom surface of the transparent substrate; the image sensor is coaxial with the window formed on the mask.

3. The image sensor package of claim 2, wherein the conductive patterns each include an inner connector, an outer connector and a conductive lines connecting the inner connector to the outer connector; the inner connectors are formed on the transparent substrate around the window of the mask and electrically connected to the image sensor; the outer connectors are formed at the periphery of the transparent substrate apart away from the inner connectors and electrically connected to the flexible circuit board.

4. The image sensor package of claim 3, wherein the image sensor further comprises a plurality of conductive bumps formed on the upper surface thereof around the sensitive zone; the conductive bumps of the image sensor are electrically connected to the inner connectors of the conducive pattern.

5. The image sensor package of claim 4 further comprising adhesive material applied between the upper surface of the image sensor and the bottom surface of the transparent substrate to cover the conductive bumps and the inner connectors of the conductive patterns.

6. The image sensor package of the claim 5 further comprising conductive glue electrically interconnecting the flexible circuit board and the outer connectors of the conductive patterns.

7. The image sensor package of the claim 1, wherein the mask is prepared from the materials consisting of chromium, chromic alloy, titanium or titanic alloy.

8. The image sensor package of the claim 5, wherein the adhesive material is made from opaque material.

9. The image sensor package of the claim 3, wherein the flexible circuit board comprises an input end and an output end extending from the input end; the opening is defined at the input end of the flexible circuit board; a number of first conductive pads are formed on the flexible circuit board around the opening and electrically connected to the outer connectors of the conductive patterns.

10. The image sensor package of the claim 9 further comprising a plurality of second conductive pads formed on the output end of the flexible circuit board, and a plurality of electronic elements electrically connected to the second conductive pads.

11. A camera module comprising:
a lens module defining a substantially flat bottom thereof;
a transparent substrate comprising an upper surface, a lower surface opposite to the upper surface, a side surface connecting the upper to the lower surfaces, the transparent substrate directly adhered to the flat bottom of the lens module via the upper surface,
a mask covering on the upper surface, the lower surface, and the side surface of the substrate;
two windows correspondingly defined in the mask at the top surface and bottom surface of the transparent substrate for the passing light there-through;
a plurality of conductive patterns formed on the mask located at the bottom surface of the transparent substrate;
an image sensor electrically connected to the conductive patterns;
a flexible circuit board electrically connected to the conductive patterns and defining an opening for receiving the image sensor therein.

12. The camera module of claim 11, wherein the image sensor comprises an upper surface and a sensitive zone formed on the middle of the upper surface; the top surface and the bottom surface are absolutely level surface and parallel with each other so as the upper surface of image is capable of substantially parallel with the upper surface and the bottom surface of the transparent substrate; the image sensor is coaxial with the window formed on the mask.

13. The camera module of claim 12, wherein the conductive patterns each include an inner connector, an outer connectors and a conductive lines connecting the inner connector to the outer connector; the inner connectors are formed on the transparent substrate around the window of the mask and electrically connected to the image sensor; the outer connectors are formed at the periphery of the transparent substrate apart away from the inner connectors and electrically connected to the flexible circuit board.

14. The image camera module of claim 13, wherein the image sensor further comprises a plurality of conductive bumps formed on the upper surface thereof around the sensitive zone; the conductive bumps of the image sensor are electrically connected to the inner connectors of the conducive pattern.

15. The camera module of claim 14 further comprising adhesive material applied into the between the upper surface of the image sensor and the bottom surface of the transparent substrate to cover the conductive bumps and the inner connectors of the conductive patterns.

16. The camera module of the claim 15 further comprising conductive glue electrically interconnecting the flexible circuit board and the outer connectors of the conductive patterns.

17. The camera module of the claim 11, wherein the mask is prepared from the materials consisting of chromium, chromic alloy, titanium or titanic alloy.

18. The camera module of the claim 15, wherein the adhesive material is made from opaque material.

19. The camera module of the claim 13, wherein the flexible circuit board comprises an input end and an output end extending from the input end; the opening is defined at the input end of the flexible circuit board; a number of first conductive pads are formed on the flexible circuit board around the opening and electrically connected to the outer connectors of the conductive patterns.

20. The image sensor package of the claim 19 further comprising a plurality of second conductive pads formed on the output end of the flexible circuit board, and a plurality of electronic elements electrically connected to the second conductive pads.
